(19) United States
(12) Patent Application Publication
(10) Pub. No.: US 2001/0033644 A1
(43) Pub. Date: Oct. 25, 2001

(54) Intelligent telecommunication network and method for operating same

(76) Inventor: Gero Offer, Gilching (DE)

Correspondence Address: William E. Vaughan, Bell, Boyd & Lloyd LLC, P.O. Box 1135, Chicago, IL, 60690-1135, US

(21) Appl. No.: 09/798,433

(22) Filed: Mar. 2, 2001

(30) Foreign Application Priority Data
Mar. 1, 2000 (DE) 10009764.2

(51) Int. Cl. H04M 7/00; H04M 3/42

(52) U.S. Cl. 379/221.08; 379/207.02

(57) ABSTRACT

Intelligent telecommunication network having a central voice storage facility, the voice storage facility having allocated to it a drive facility for triggering and performing a call recording after a call set-up between two terminals of the telecommunication network in dependence on a trigger signal transmitted by one of the terminals and/or on condition data stored in the drive facility.

### BACKGROUND OF THE INVENTION

1. Field of the Invention

The present invention relates to an intelligent telecommunication network having a central voice storage facility and a method for operating such a telecommunication network.

2. Description of the Prior Art

Private and business life cannot be imagined without telephone conversations which have gained even more significance with the explosive development of mobile radio technology in both areas of life. The ever increasing spread of the range of goods and services offered in, or using telecommunication networks has also contributed to this. High-quality goods and services which, in the past, could only be supplied on the basis of a written purchase agreement, are also delivered or, respectively, supplied and paid on the basis of agreements made over the telephone.

As a result, the very old need for a simple and reliable recording of telephone calls has become more relevant.

The local recording of telephone calls via a recording device (for example, audio tape or dictating machine) connected to the terminal of the user has been known for a long time and is also practiced to a certain, although comparatively small, extent. A comparable solution is voice storage in voice computers of companies; for example, direct banks which rely heavily on documentation of orders obtained over telephone for safeguarding their business arrangements. These local solutions require a high expenditure on implementation for the user, entailing corresponding equipment and labor costs. In addition, such solutions require an ongoing operating expenditure. Overall, this results in a disadvantageous cost/profit ratio, especially for relatively small companies and private persons.

In modern telecommunication networks, answering machine functions are implemented on the basis of central voice storage facilities which are provided to the user of the system as a special service (free of charge or chargeable).

The present invention is therefore directed to providing a simple, inexpensive way of recording telephone conversations which, in principle, is easily available to any user.

### SUMMARY OF THE INVENTION

Accordingly, the present invention includes the fundamental concept of implementing voice storage during the existence of a connection between two terminals in an intelligent telecommunication network. In particular, the recording takes place optionally in dependence on a trigger signal which is transmitted from (at least) one of the terminals and/or on condition data stored in the system; i.e., at the service server.

The condition data mentioned is suitably stored in a first user profile memory having a number of memory areas (which are preferably dynamically configurable in the usual manner) which can be addressed via the associated terminal number of the user. The memory areas in each case contain a condition data record for the conditional triggering of a recording of a conversation. Such a data record includes, in particular, a call number list of terminals for which the user generally requires a recording of the conversations, and/or other data which describe additional “fixed” conditions (for example clock times).

On the other hand, the control for the voice storage facility has the ability to receive means for receiving trigger signals which are generated at the terminal of the user; for example, by operating a hot key or a key combination or in conjunction with a so-called “prefix” to an outgoing call.

The control (controlling device) furthermore has the ability to receive status signals with respect to the connection to be recorded; that is, in particular, for receiving a call acceptance signal (“CONN” in the ISDN system), a call disconnection signal (“DISC” in the ISDN system) and, respectively, a status signal (“STAT”) output during the existence of a connection.

In an embodiment of the present invention, processing of the recordings is also provided in the IN service providing the call recording. This processing consists, in particular, in adding a control and/or supplementary information or, respectively, speech/text conversion for providing the recorded information as a text file. furthermore, the processing can include a translation or also a synopsis of content according to predetermined descriptors or the like, in conjunction with a knowledge management system.

Processing is done on the basis of supplementary data previously stored and/or currently transmitted in conjunction with the existing call connection, which have the form of text or control data or also of voice data. This includes, in particular, identification and possibly, also authentication data relating to the call parties, preconfigured or currently transmitted accompanying information (such as, for example, distribution, diary or processing notes for a third party) or control data relating to the processing process of a forwarding process.

In a further embodiment, the IN service includes forwarding functions. They may relate directly to the voice recording or to a processing result and, in particular, consist in the forwarding of the voice message to a predetermined terminal number or in the forwarding of a text file, generated from the voice message, to a predetermined E-mail address of a data network linked to the telecommunication network.

The corresponding processing or transmitting facility for implementing the advantageous supplementary functions is preferably associated with a second user profile memory in which, in turn, a number of memory areas are provided for addressing via the terminal number of a user of the service for storing permanently preset processing and forwarding criteria, respectively.

For limiting the memory and control resources needed in the service server, the system overall contains a recording management system which, in particular, implements overwriting of recordings which have not been forwarded nor retrieved, after a certain period of storage, the transfer of recordings to an external archiving memory or the like. This administrative function can be implemented in conjunction with the implementation of the processing and forwarding function.

Overall, the proposed functionality can be implemented with extensive utilization of the so-called Unified Messaging structure of a modern intelligent network. The voicemail boxes of the ISDN and of the mobile radio networks, known per se, also must be incorporated into the proposed system.

The proposed solution provides the user with a new value-added service which provides for valuable documentation of business (or else private) incidences without any own prior material expenses and should, therefore, be offered as a chargeable service, in principle. Charging can be done at a flat rate (for example with a monthly flat rate) but will be preferably set up related to use; that is, independence on the recorded volume of data and/or the number of call recordings per unit time. Processing and forwarding functions can be billed separately or also can be inclusive (up to a certain complexity, in any case). Corresponding billing mechanisms are known in principle and are also used in modern telecommunications systems so that a more detailed description can be omitted here.

Additional features and advantages of the present invention are described in, and will be apparent from, the Detailed Description of the Preferred Embodiments and the Drawings.

### DESCRIPTION OF THE DRAWINGS

FIG. 1 shows an intelligent telecommunication network in accordance with the teachings of the present invention.

### DETAILED DESCRIPTION OF THE PREFERRED EMBODIMENTS

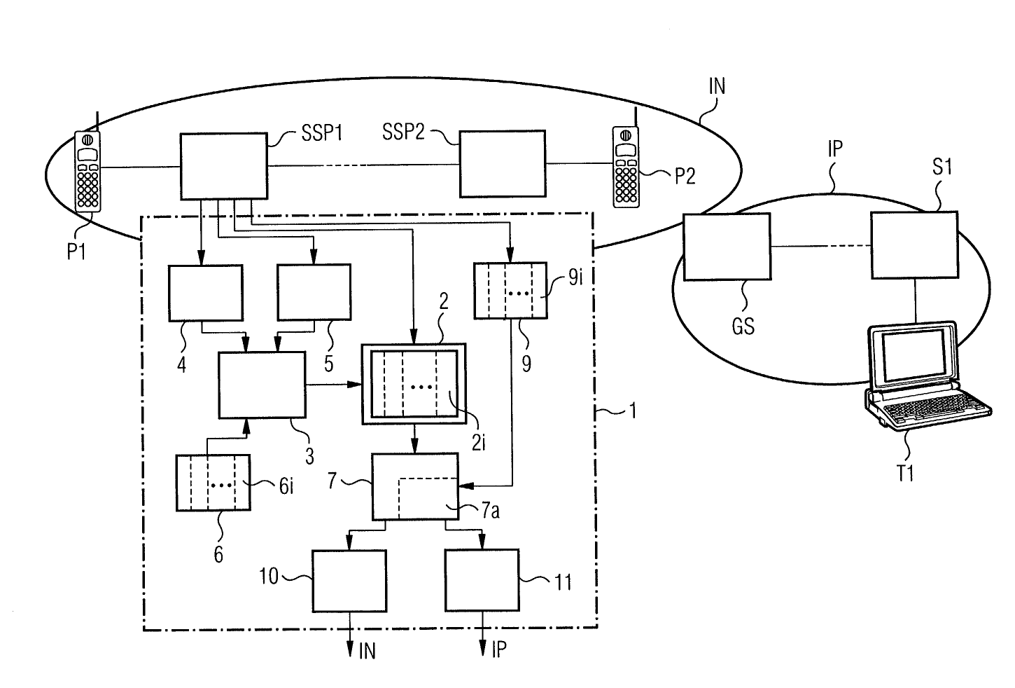

FIG. 1 shows an intelligent telecommunication network IN—which can be constructed as a line-connected network (land line network) or a mobile radio network—having two telephone terminals P1 and P2 which are connected one exchange SSP1 and SSP2, respectively. The telecommunication network IN is connected via a gateway server GS to a data network IP to which a data terminal T1 is connected via an access server S1. The call recording service is implemented on a service server 1. Its functions are shown in FIG. 1 in the form of a functional block diagram and, correspondingly, the subsequent description in each case talks of “facilities”. The expert will understand that the implementation takes place largely with respect to software in a processor structure in which these facilities are not structurally delimited in every case.

Server 1 includes a voice storage facility 2 with a multiplicity of memory areas 2i which can be individually addressed and which are respectively assigned to a registered user of the service and can be addressed on the basis of his/her terminal call number. The voice storage facility 2 has allocated to it a drive unit 3 for controlling the individual call recording processes which, in turn, is connected at the input to a status signal receiving unit 4 and a trigger signal receiving unit 5 and a first user profile memory 6.

The status signal receiving unit 4 and the trigger signal receiving unit 5 are connected to the first exchange SSP1 and, via this exchange, to the first telephone terminal P1 in the example shown. From there, they receive status signals with respect to the existence of a connection between the telephone terminals P1 and P2 and, respectively, trigger signals emanating from the terminal P1 or input to the latter, for call recordings. The terminal outputs such trigger signals, in particular, when certain key combinations or a hot key are operated for initiating or terminating a recording during a call in progress.

The first user profile memory 6 includes, in an area arrangement corresponding to the voice storage facility 2, a number of memory areas 6i which are, in each case, assigned to a user and in which a condition data record is, in each case, stored in the form of a user profile for the call recordings implemented in the service. This is, in particular, a list of subscriber call numbers for which the user of the terminal P1 wishes to have a recording of his conversations.

At the output end, the voice storage facility 2 is connected to a processing facility 7 which, in turn, may include a number of function sub-units. In the FIG. 1, a voice/text converter station 7a is shown as such a unit. The processing facility 7 is connected at the input to a second user profile memory 8, the structure of individual memory areas of which corresponds to that of the first user memory profile 6 and the voice storage facility 2. In this memory, user profiles are stored with regard to further processing of recorded call messages.

Furthermore, the processing facility 7 is also connected to the status signal receiving facility 4 and the trigger signal receiving facility 5 in order to obtain from these additional control signals for further processing of the call recording as can be input, for example, by the user at his terminal P1. Finally, a further input of the processing facility 7 is connected to a supplementary information memory 9 in which certain supplementary information can be stored or temporarily stored (again. in memory areas 9i assigned to the individual users in each case) which are added to the actual call recording in the processing facility 7.

At the output end, the processing facility 7 in the example shown is connected to two transmitting facilities 10 and 11, the first transmitting facility 10 of which is constructed for forwarding voice messages to predetermined call numbers in the telecommunication network IN—for example also to the first terminal P1 itself, whereas the second transmitting facility 11 is constructed for transmitting text files, generated by the voice/text converter station 7a, per E-mail to the data terminals in the data network IP, preferably also an own data terminal of the user of the telephone terminal P1.

Finally, the voice storage facility 2 is connected to a charge metering facility 12 which charges for the call recording service in dependence on the recording period or, respectively, recorded volume of data.

Using such a configuration, the following applications can be implemented:

share orders per telephone. The user profile here includes the terminal call numbers of the customers of the broker. The call is additionally recorded under control by key inputs at his terminal especially for calls in which orders are pronounced. During post processing of the recordings, order files are immediately generated which are routed to the PC of the broker wherein they provide for processing via the data network (internet) which immediately follows the telephone conversation.

Service hotline. In this application, all incoming calls are recorded, in the simplest case without filtering, by a user profile but preferably with the possibility of triggering or terminating the recording during a call in progress via key inputs by the operator. During the recording of the request or immediately thereafter, the recording can be provided with supplementary information generated by the operator, for example a forwarding address matching the content of the request by the caller.

Either the voice message directly or a text file generated from it by voice/text conversion are then forwarded to a service technician who is responsible for technical aspects of the request of the caller. Similarly, but already with evaluation of the area code component of the subscriber call number as supplementary information, recorded call messages can be distributed in accordance with territorial responsibilities of the service employees. In parallel, central documentation of the request/orders received is advantageously possible for the purpose of overall monitoring of the service operation and for statistical evaluations.

Sales system with commercial representatives or, respectively “field service”. Reciprocal to the procedure in the case of the aforementioned service hot line, as it were, customer calls with requests or orders accumulating at the individual representatives or field workers are centrally recorded here as part of the call recording service and forwarded to third parties. again as voice or text message via telecommunication or data network, in dependence on a content classification during the acceptance of the call, or retrieved again for later evaluation by the accepting person himself. The accepting person can add supplementary information by voice input or DTMF process or similar. Here, too, the proposed solution at the same time provides overall documentation and evaluation of the customer contacts.

Although the present invention has been described with reference to specific embodiments, those of skill in the art will recognize that changes may be made thereto without departing from the spirit and scope of the invention as set forth in the hereafter appended claims.

I claim as my invention:

1. An intelligent communication network, comprising:
a central voice storage facility;
at least two communication terminals of the telecommunication network; and
a driver facility allocated to the central voice storage facility, the drive facility triggering and executing a call recording, after a connection set-up between the at least two communication terminals, in dependence on at least one of a trigger signal transmitted by one of the at least two communication terminals and condition data stored in the drive facility.

2. An intelligent telecommunication network as claimed in claim 1, further comprising:
a service server incorporating both the central voice storage facility and the drive facility, wherein the service server is subject to registration and charges, and each user is allocated a terminal-related memory address of the voice storage facility.

3. An intelligent telecommunication network as claimed in claim 1, further comprising:
a first user profile memory connected to the drive facility, the first user profile memory including a plurality of memory areas in which condition data records are stored in correlation with terminal numbers, the data records including terminal call number lists for conditional triggering of a call recording.

4. An intelligent telecommunication network as claimed in claim 1, further comprising:
a status signal receiving facility connected to the drive facility, the status signal receiving facility for receiving a call acceptance signal, a disconnect signal and a status signal; and
a trigger signal receiving facility connected to the drive facility, the trigger signal receiving facility for receiving trigger signals including information signals generated by one of the at least two communication terminals via one of a hot key and a key combination.

5. An intelligent telecommunication network as claimed in claim 1, further comprising:
a processing facility connected to the voice storage facility, the processing facility for adding one of a control information item and a supplementary information item and for converting voice and text of call recordings.

6. An intelligent telecommunication network as claimed in claim 5, further comprising:
a temporary supplementary memory connected to the processing facility, the temporary supplementary memory for connection to a user terminal, defined as one of the at least two communication terminals, for storing one of connection-related data, voice and text, and control data additionally transmitted via the user terminal.

7. An intelligent telecommunication network as claimed in claim 1, further comprising:
a transmitting facility allocated to the voice storage facility, the transmitting facility for forwarding call recordings in dependence on at least one of a forwarding signal transmitted by one of the at least two communication terminals and condition data stored in the transmitting facility including a predetermined terminal call number.

8. An intelligent telecommunication network as claimed in claim 5, further comprising:
a second user profile memory allocated to at least one of the processing facility and the transmitting facility, the second user profile memory including a plurality of memory areas in which condition data records for at least one of the conditional processing and forwarding of call recordings are respectively formed in correlation with terminal numbers.

9. An intelligent telecommunication network as claimed in claim 5, wherein the transmitting facility follows the processing facility for forwarding call recordings processed in advance including a predetermined E-mail address of a data network linked to the telecommunication network.

10. An intelligent telecommunication network as claimed in claim 5, further comprising:
a call message administrating facility formed from at least one of the processing facility and the transmitting facility, the call message administrating facility for administering a memory content of the voice storage facility, including one of overwriting and transferring call recordings into an archiving memory on the basis of at least one of service-related criteria and control signals which are one of predetermined by a user and currently transmitted.

11. A method for operating an intelligent telecommunication network, the method comprising the steps of:
establishing a connection between two communication terminals of the telecommunication network; and
performing a central call recording in the intelligent telecommunication network during the existence of the connection.

12. A method for operating an intelligent telecommunication network as claimed in claim 11, further comprising the step of:
enabling the central call recording in dependence on at least one of a trigger signal transmitted by one of the at least two communication terminals and on previously stored condition data.

13. A method for operating an intelligent telecommunication network as claimed in claim 11, the method further comprising the step of:
performing a processing step after the step of performing a central call recording, which is at least one of for adding a control information item and a supplementary information item and for voice and text conversion.

14. A method for operating an intelligent telecommunication network as claimed in claim 11, the method further comprising the step of:
forwarding the call recording after the step of performing the central call recording, to one of a predetermined terminal call number and a predetermined E-mail address of a data network linked to the telecommunication network.
